(19) United States
(12) Patent Application Publication
(10) Pub. No.: US 2016/0164057 A1
(43) Pub. Date: Jun. 9, 2016

(54) ELECTROCHEMICAL CELL WITH POLYIMIDE SEPARATOR AND HIGH-VOLTAGE POSITIVE ELECTRODE

(71) Applicant: E I DU PONT DE NEMOURS AND COMPANY, Wilmington, DE (US)

(72) Inventors: PANKAJ ARORA, CHESTERFIELD, VA (US); MARK GERRIT ROELOFS, EARLEVILLE, MD (US)

(21) Appl. No.: 14/958,958

(22) Filed: Dec. 4, 2015

Related U.S. Application Data
(60) Provisional application No. 62/197,730, filed on Jul. 28, 2015.
(60) Provisional application No. 62/087,830, filed on Dec. 5, 2014.

(51) Int. Cl. H01M 2/16; H01M 10/0525; H01M 10/0567; H01M 4/505; H01M 4/525

(52) U.S. Cl. CPC H01M 2/162; H01M 4/505; H01M 4/525; H01M 10/0567; H01M 10/0525; H01M 2004/028

(57) ABSTRACT

Disclosed herein is an electrochemical cell comprising a housing containing an electrolyte composition, and a multi-layer article at least partially immersed in the electrolyte composition;
wherein the multi-layer article comprises a first metallic current collector, a negative electrode material in electrically conductive contact with the first metallic current collector, a positive electrode material in ionically conductive contact with the negative electrode material, a porous separator disposed between and contacting the negative electrode material and the positive electrode material, and a second metallic current collector in electrically conductive contact with the positive electrode material;
wherein the porous separator comprises a nanoweb that comprises a plurality of nanofibers, wherein the nanofibers consist essentially of a fully aromatic polyimide; and
wherein the positive electrode is charged above 4.4 V versus a Li metal reference electrode.

### CROSS-REFERENCE TO RELATED APPLICATIONS

This application claims the benefit of U.S. Provisional Application Nos. 62/087,830 filed on Dec. 5, 2014, and 62/197,730 filed on Jul. 28, 2015, which are incorporated herein by reference in their entirety.

### FIELD OF THE INVENTION

The present invention relates to a high-voltage electrochemical cell comprising a polyimide separator.

### BACKGROUND

One method to increase the energy of lithium batteries is to increase their average operating voltage, either through an increase in the potential of the positive electrode or a decrease in the potential of the negative electrode, or both of these. A positive electrode used in some commercial lithium-ion batteries is LiFePO₄ which is charged to an upper cutoff voltage of about 3.7 V vs a Li⁺/Li reference electrode. However positive electrodes such as LiCoO₂, Li(NiₓMn_{y}Co_{z})O₂ (x+y+z=1), LiMn₂O₄, have generally been charged to an upper voltage of about 4.2-4.3 V. In order to increase the capacity, cells with these cathodes are now being charged to voltages above 4.3 V. In addition, alternative positive electrodes have been developed which are charged to higher voltages in the range of 4.4-5.2 V, including LiCoPO₄, Li₂MnO₃⁻LiMO₂ layered-layered composites, LiNi_{0.5}Mn_{1.5}O₄, and metal substituted versions of these. However, other components of the cell, including electrolyte, electrode binders, separators, and/or current collectors may suffer from degradation when subjected to such high potentials. These issues result in reduced battery life when using high voltage positive electrodes.

The requirements for choosing an improved separator for Li-ion batteries and other high energy density electrochemical devices are complex. A suitable separator combines good electrochemical properties, such as high electrochemical stability, charge/discharge/recharge hysteresis, first cycle irreversible capacity loss and the like, with good mechanical and thermal properties.

Typically polyolefins (polypropylene, polyethylene, etc.) are used as separators for lithium based batteries. They perform well for batteries which operates around 4.2V, but can start showing significant capacity degradation when exposed to higher voltages during long term cycling.

Investigations concerning known high performance polymers for use as battery separators have been undertaken. One such class of polymers has been polyimides.

A need nevertheless remains for Li and Li-ion batteries prepared from materials that combine good electrochemical properties, such as high voltage electrochemical stability, charge/discharge/recharge hysteresis, first cycle irreversible capacity loss and the like, with good mechanical aspects such as strength, toughness and thermal stability.

### SUMMARY

Disclosed herein is an electrochemical cell comprising a housing containing an electrolyte composition, and a multi-layer article at least partially immersed in the electrolyte composition;
wherein the multi-layer article comprises a first metallic current collector, a negative electrode material in electrically conductive contact with the first metallic current collector, a positive electrode material in ionically conductive contact with the negative electrode material, a porous separator disposed between and contacting the negative electrode material and the positive electrode material, and a second metallic current collector in electrically conductive contact with the positive electrode material;
wherein the porous separator comprises a nanoweb that comprises a plurality of nanofibers, wherein the nanofibers consist essentially of a fully aromatic polyimide; and
wherein the positive electrode material is charged above 4.4 V versus a Li metal reference electrode.

In one embodiment, the nanoweb consists essentially of polyimide nanofibers formed from pyromellitic dianhydride and oxy-dianiline. In another embodiment, the positive electrode has a capacity of greater than about 40 mAh/g in a voltage range greater than about 4.6 V.vs Li/Li+. In an embodiment, the electrolyte composition comprises at least one electrolyte salt and greater than about 20 weight percent of at least one fluorinated acyclic carboxylic acid ester, fluorinated acyclic carbonate, fluorinated acyclic ether, or mixture thereof;

wherein
the fluorinated acyclic carboxylic acid ester is represented by the formula R¹—COO—R²;
the fluorinated acyclic carbonate is represented by the formula R³—OCOO—R⁴; and
the fluorinated acyclic ether is represented by the formula R⁵—O—R⁶;
   wherein
i) R¹ is H, an alkyl group, or a fluoroalkyl group;
ii) R³ and R⁵ is each independently a fluoroalkyl group and can be either the same as or different from each other;
iii) R², R⁴, and R⁶ is each independently an alkyl group or a fluoroalkyl group and can be either the same as or different from each other;
iv) either or both of R¹ and R² comprises fluorine; and
v) R¹ and R², R³ and R⁴, and R⁵ and R⁶, each taken as a pair, comprise at least two carbon atoms but not more than seven carbon atoms.

### DETAILED DESCRIPTION

The meaning of abbreviations used is as follows: “g” means gram(s), “mg” means milligram(s), “μg” means microgram(s), “L” means liter(s), “mL” means milliliter(s), “mol” means mole(s), “mmol” means millimole(s), “M” means molar concentration, “wt %” means percent by weight, “nm” means nanometer(s), “Hz” means hertz, “mS” means millisiemen(s), “mA” mean milliamp(s), “mAh/g” mean milliamp hour(s) per gram, “V” means volt(s), “SOC” means state of charge, “rpm” means revolutions per minute.

As used above and throughout the disclosure, the following terms, unless otherwise indicated, shall be defined as follows:

The term “electrolyte composition” as used herein, refers to a chemical composition suitable for use as an electrolyte in an electrochemical cell, such as a lithium ion battery. An electrolyte composition typically comprises at least one solvent and at least one electrolyte salt.

The term “electrolyte salt” as used herein, refers to an ionic salt that is at least partially soluble in the solvent of the electrolyte composition and that at least partially dissociates into ions in the solvent of the electrolyte composition to form a conductive electrolyte composition.

The term “negative electrode” refers to the electrode of an electrochemical cell, at which oxidation occurs. In a galvanic cell, such as a battery, the negative electrode is the negatively charged electrode. In a secondary (i.e. rechargeable) battery, the negative electrode is the electrode at which oxidation occurs during discharge and reduction occurs during charging.

The term “positive electrode” refers to the electrode of an electrochemical cell at which reduction occurs. In a galvanic cell, such as a battery, the positive electrode is the positively charged electrode. In a secondary (i.e. rechargeable) battery, the positive electrode is the electrode at which reduction occurs during discharge and oxidation occurs during charging.

The term “lithium ion battery” as used herein refers to a type of rechargeable battery in which lithium ions move from the negative electrode to the positive electrode during discharge, and from the positive electrode to the negative electrode during charge.

Equilibrium potential between lithium and lithium ion is the potential of a reference electrode using lithium metal in contact with the non-aqueous electrolyte containing lithium salt at a concentration sufficient to give about 1 mole/liter of lithium ion concentration, and subjected to sufficiently small currents so that the potential of the reference electrode is not significantly altered from its equilibrium value (Li/Li⁺). The potential of such a Li/Li⁺ reference electrode is assigned here the value of 0.0V. Potential of a negative electrode or a positive electrode means the potential difference between the negative electrode or positive electrode and that of a Li/Li⁺ reference electrode. Herein voltage means the voltage difference between the positive electrode and the negative electrode of a cell, neither electrode of which may be operating at a potential of 0.0V.

The term “alkyl group”, as used herein, refers to a saturated linear or branched chain hydrocarbon radical containing from 1 to 10 carbon atoms. Examples of alkyl groups include methyl, ethyl, n-propyl, n-butyl, isobutyl, sec-butyl, tert-butyl, pentyl, isoamyl, hexyl, heptyl, and octyl.

The term “fluoroalkyl group”, as used herein, refers to an alkyl group wherein at least one hydrogen is replaced by fluorine.

The term “carbonate” as used herein refers specifically to an organic carbonate, wherein the organic carbonate is a dialkyl diester derivative of carbonic acid, the organic carbonate having a general formula R′OCOOR″, wherein R′ and R″ are each independently selected from alkyl groups having at least one carbon atom, wherein the alkyl substituents can be the same or different, saturated or unsaturated, substituted or unsubstituted, can form a cyclic structure via interconnected atoms, and/or include a cyclic structure as a substituent of either or both of the alkyl groups.

Described herein is an electrochemical cell comprising a housing containing an electrolyte composition, and a multi-layer article at least partially immersed in the electrolyte composition;
wherein the multi-layer article comprises a first metallic current collector, a negative electrode material in electrically conductive contact with the first metallic current collector, a positive electrode material in ionically conductive contact with the negative electrode material, a porous separator disposed between and contacting the negative electrode material and the positive electrode material, and a second metallic current collector in electrically conductive contact with the positive electrode material;
wherein the porous separator comprises a nanoweb that comprises a plurality of nanofibers, wherein the nanofibers consist essentially of a fully aromatic polyimide; and
wherein the positive electrode material is charged above 4.4 V versus a Li metal reference electrode.

In one embodiment, the polyimide separator comprises a nanoweb comprising nanofibers with a fiber size less than about 1000 nanometers in diameter. The term “nanofibers” as used herein refers to fibers having a number average diameter less than 1000 nm, or less than 800 nm, or between about 50 nm and 500 nm, or between about 100 and 400 nm. The fiber diameters are measured by examination in a scanning electron microscope with calibrated magnification. In the case of non-round cross-sectional nanofibers, the term “diameter” as used herein refers to the greatest cross-sectional dimension.

As used herein, the term “web” refers to a network of fibers. The fibers can be bonded to each other, or can be unbonded and entangled to impart strength and integrity to the web. The fibers can be oriented or randomly distributed with no overall repeating structure discernible in the arrangement of fibers. The fibers can be staple fibers or continuous fibers, and can comprise a single material or a multitude of materials, either as a combination of different fibers or as a combination of similar fibers each comprising of different materials.

As used herein, the term “nanoweb” refers to a nonwoven web constructed predominantly of nanofibers. “Predominantly” means that greater than 50% by number of the fibers in the web are nanofibers. In one embodiment, the nanoweb disclosed herein contains greater than 50% by number of nanofibers. In one embodiment, the nanoweb contains greater than 70% by number of nanofibers. In one embodiment, the nanoweb contains greater than 90% by number of nanofibers. In one embodiment, the nanoweb contains 100% nanofibers.

As used herein, the term “polyimide nanoweb” refers to a nanoweb comprising nanofibers of a polyimide.

The nanowebs employed herein define a planar structure that is relatively flat, flexible and porous, and is formed by the lay-down of one or more continuous filaments.

Nanowebs can be fabricated by any suitable process, such as electroblowing, electrospinning, and melt blowing. Electroblowing of polymer solutions to form a nanoweb is described in Kim et al., published U.S. Patent Application No. 2005/0067732. More details on the preparation of nanowebs suitable for use in an electrochemical cell can be found in published U.S. Patent Application No. 2011/0143217. In one embodiment, a polyimide nanoweb is prepared by one or more of electrospinning and electroblowing. In one embodiment, a porous separator comprises a polyimide nanoweb prepared by one or more of electrospinning and electroblowing.

The nanofibers can consist essentially of one or more fully aromatic polyimides. For example, the nanofibers may be prepared from more than 80 wt % of one or more fully aromatic polyimides, more than 90 wt % of one or more fully aromatic polyimides, more than 95 wt % of one or more fully aromatic polyimides, more than 99 wt % of one or more fully aromatic polyimides, more than 99.9 wt % of one or more fully aromatic polyimides, or 100 wt % of one or more fully aromatic polyimides.

As employed herein, the term “fully aromatic polyimide” refers specifically to polyimides that are at least 90% imidized and wherein at least 95% of the linkages between adjacent phenyl rings in the polymer backbone are effected either by a covalent bond or an ether linkage. Up to 25%, for example up to 20%, or for example up to 10%, of the linkages may be effected by aliphatic carbon, sulfide, sulfone, phosphide, or phosphone functionalities, or a combination thereof. Up to 5% of the aromatic rings making up the polymer backbone may have ring substituents of aliphatic carbon, sulfide, sulfone, phosphide, or phosphone functionalities. As used herein, the term “90% imidized” means that 90% of the amic acid functionality of the polyamic acid precursor has been converted to imide. Preferably the fully aromatic polyimide suitable for use in the present invention is 100% imidized, and preferably contains no aliphatic carbon, sulfide, sulfone, phosphide, or phosphone functionalities.

Polyimide nanowebs suitable for use are prepared by imidization of the polyamic acid nanoweb where the polyamic acid is a condensation polymer prepared by reaction of one or more aromatic dianhydrides and one or more aromatic diamines. Suitable aromatic dianhydrides include but are not limited to pyromellitic dianhydride (PMDA), biphenyltetracarboxylic dianhydride (BPDA), and mixtures thereof. Suitable diamines include but are not limited to oxydianiline (ODA), 1,3-bis(4-aminophenoxy)benzene (RODA), and mixtures thereof. Preferred dianhydrides include pyromellitic dianhydride, biphenyltetracarboxylic dianhydride, and mixtures thereof. Preferred diamines include oxydianiline, 1,3-bis(4-aminophenoxy)benzene and mixtures thereof. Most preferred are PMDA.and ODA.

In the polyamic acid nanoweb imidization process hereof, the polyamic acid is first prepared in solution; typical solvents are dimethylacetamide (DMAC) or dimethyformamide (DMF). In one method suitable for the nanowebs disclosed herein, the solution of polyamic acid is formed into a nanoweb by electroblowing. In an alternative suitable method, the solution of polyamic acid is formed into a nanoweb by electrospinning as described in Huang et al., Advanced Materials Volume 18, Issue 5, pages 668-671, March, 2006, DOI: 10.1002/adma.200501806. In either case, it is necessary that the nanoweb be formed from the polyamic acid solution, and the resulting nanoweb then be subject to imidization, as the fully aromatic polyimides employed in the nanoweb separators disclosed herein are highly insoluble. This is in contrast to the solvent-soluble polyimides employed in the nanoweb separators disclosed in the art, and used in electrochemical cells known in the art, which could be either electroblown or electrospun in a solution of the polyimide or a solution of the polyamic acid followed by imidization.

The nanoweb separators can be prepared by a method for enhancing the properties of the polyimide nanoweb separators by subjecting the polyimide nanoweb to a temperature at least 50° C. higher than the imidization temperature thereof for a period of 5 seconds to 20 minutes. The resulting nanoweb is stronger and less solvent absorbent than the same nanoweb before treatment.

Imidization of the polyamic acid nanoweb may conveniently be performed by first subjecting the nanoweb to partial solvent removal at a temperature of about 100° C. in a vacuum oven with a nitrogen purge; following extraction, the nanoweb is then heated to a temperature of 300° C. to 350° C., or above 400° C., for about 10 minutes or less, for example 5 minutes or less, or for example 30 seconds or less, to fully imidize the nanoweb. Imidization according to the process described herein results in at least 90%, preferably 100%, imidization. Under most circumstances, analytical methods show that 100% imidization is rarely achieved, even after long imidization times. For practical purposes, complete imidization is achieved when the slope of the percentage imidization versus time curve is zero.

In one embodiment, the polyimide nanoweb consists essentially of polyimide nanofibers formed from pyromellitic dianhydride (PMDA) and oxy-dianiline (ODA), having monomer units represented by Structure I:

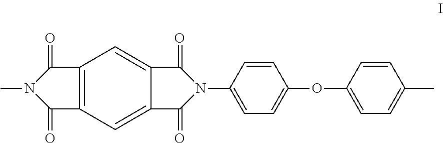

Polyimides are typically referred to by the names of the condensation reactants that form the monomer unit. That practice will be followed herein. Thus, the polyimide consisting essentially of monomer units represented by Structure I is designated PMDA/ODA. In one embodiment, the polyimide nanoweb comprises polyimide nanofibers formed from PMDA/ODA.

A suitable aromatic polyimide nanoweb can be a so-called enhanced nanoweb characterized by a crystallinity index of at least 0.1, or at least 0.2. In one embodiment, the enhanced nanoweb consists essentially of nanofibers of PMDA/ODA having a crystallinity index of at least 0.1. An enhanced aromatic polyimide nanoweb is characterized by higher strength, lower electrolyte solvent uptake, and reduced electrolyte solvent-induced loss in physical properties versus a corresponding aromatic polyimide nanoweb that is not enhanced. It is believed that the observed enhancement in properties of the enhanced aromatic polyimide nanoweb is at least partially accounted for by an increase in crystallinity that develops during the process for preparing an enhanced nanoweb.

A suitable enhanced aromatic polyimide nanoweb is prepared by heating an aromatic polyimide nanoweb within an annealing range. The annealing range depends highly on the composition of the material. The annealing range is 400-500° C. for PMDA/ODA. For BPDA/RODA it is around 200° C.; BPDA/RODA will decompose if heated to 400° C. In general terms, the annealing range begins at least 50° C. above the imidization temperature. As used herein, the imidization temperature for a given aromatic polyamic acid nanoweb is the temperature below 500° C. at which in thermogravimetric analysis, at a heating rate of 50° C./min, the % weight loss/° C. decreases to below 1.0, preferably below 0.5, with a precision of ±0.005% in weight % and ±0.05° C. The fully aromatic polyimide nanoweb is subject to heating in the annealing range for a period of time from 5 seconds to 20 minutes, for example from 5 seconds to 10 minutes.

In one embodiment, a PMDA/ODA amic acid nanoweb produced by condensation polymerization from solution followed by electroblowing of the nanoweb is first heated to about 100° C. in a vacuum oven to remove residual solvent. Following solvent removal, the nanoweb is heated to a temperature in the range of 300-350° C. and held for a period of less than 15 minutes, for example less than 10 minutes, or less than 5 minutes, until at least 90% of the amic functionality has been converted (imidized) to imide functionality, preferably until 100% of the amic functionality has been imidized. The thus imidized nanoweb is then heated to a temperature in the range of 400° C. to 500° C., preferably in the range of 400° C. to 450° C., for a period of 5 seconds to 20 minutes, until a crystallinity index of 0.2 is achieved.

The parameter “crystallinity index” as employed herein refers to a relative crystallinity parameter determined from Wide-Angle X-ray Diffraction (WAXD). The WAXD scan consists of 1) a background signal; 2) scattering from ordered but amorphous regions; and 3) scattering from crystalline regions. The ratio of the integral under the peaks identified as crystalline peaks to the integral under the overall scan curve with the background subtracted is the crystallinity index.

In another embodiment, the polyimide separator has a thickness of about 5 to about 50 micrometers, or about 10 to about 30 micrometers, or about 12 to about 25 micrometers, or greater than about 12 micrometers.

In an embodiment, the polyimide becomes partially reduced upon contact with the graphite anode in an electrochemical cell. This electrochemical reduction reaction could potentially contribute to capacity loss in the electrochemical cell via redox exchange reactions, as reported by Mazur et al in J. Electrochem Soc., 1987, 346. Thus, a protective region disposed between the web and the electrodes wherein the protective region impedes electrochemical polyimide reduction provides further advantage of reducing self-discharge capacity loss in an electrochemical cell.

As used herein, the term “protective region” refers to an electrochemically inert area that surrounds or covers the fibers without completely occluding the pores of the nanoweb.

In an embodiment, the protective region comprises a coating on the fibers comprising particles of (a) oxides of silicon, aluminum, calcium, or mixtures thereof, ranging from about 1 to about 20,000 nm, from about 1 to about 10,000 nm, or from about 1 to about 4,000 nm in diameter, and, optionally, a binder; (b) oxides of zirconium, tantalum, silicon, hafnium, or mixtures thereof; (c) silanes, (d) silsesquioxanes; (e) organic polymers characterized with a Hansen solubility parameter (δp) of at most about 19.2 MPa^{1/2} or at least about 23.2 MPa^{1/2}; or (f) mixtures thereof.

As used herein, the term “coating” is defined as a material being present on at least a portion of the filament of the nanoweb.

As used herein, the term “conformal coating” is defined as a coating that mimics the shape and surface of the filament of the nanoweb. As used herein, the term “non-conformal coating” is defined as a coating that contains non-uniformities in mimicking the shape and surface of the filaments on a portion of the nanoweb.

In an embodiment, the protective region comprising a coating on the fibers has an average thickness in the range of one of: from about 0.1 nm to about 5000 nm, or from about 1 nm to about 175 nm, or from about 2 nm to about 100 nm.

In an embodiment, the protective region comprising a coating on the fibers is a conformal coating or a non-conformal coating.

In one embodiment, the protective region impedes electrochemical polyimide reduction resulting in a protection efficiency for at least one electrode from one of: at least about 10%, at least about 20%, or at least about 30%.

As used herein, the term “protection efficiency” is defined as:

η (%)=[1−(amount of electrochemically reduced polyimide in presence of protective region at the positive electrode/amount of electrochemically reduced polyimide in the absence of protective region at the positive electrode)]×100%.

In the following the voltage of positive electrodes is given relative to a reference electrode of Li/Li⁺. The Li/Li⁺ reference electrode is typically defined to be 0 V.

In another embodiment, the positive electrode in the lithium ion battery hereof comprises a positive electrode active material exhibiting greater than 40 mAh/g of reversible capacity in the potential range greater than 4.4 V, or 4.6 V, or 4.8 V. Such positive electrode active materials for a lithium ion battery include without limitation electroactive compounds comprising lithium and transition metals, such as LiCoO₂, LiNiO₂, LiMn₂O₄, LiCo_{0.2}Ni_{0.2}O₂ or LiV₃O₈;

LiₐCoG_{b}O₂ (0.90≦a≦1.8, and 0.001≦b≦0.1);

LiₐNi_{b}Mn_{c}Co_{d}RₑO_{2-f}Z_{f} where 0.8≦a≦1.2, 0.1≦b≦0.9,

0.0≦c≦0.7, 0.05≦d≦0.4, 0≦e≦0.2, wherein the sum of b+c+d+e is about 1, and 0≦f≦0.08;

LiₐA_{1-b}, R_{b}D₂ (0.90≦a≦1.8 and 0≦b≦0.5);

LiₐE_{1-b}R_{b}O_{2-c}D_{c} (0.90≦a≦1.8, 0≦b≦0.5 and 0≦c≦0.05);

LiₐNi_{1-b-c}Co_{b}R_{c}O_{2-d}Z_{d} where 0.9≦a≦1.8, 0≦b≦0.4, 0≦c≦0.05, and 0≦d≦0.05;

Li_{1+z}Ni_{1-x-y}CoₓAl_{y}O₂ where 0<x<0.3, 0<y<0.1, and 0<z<0.06;

LiNi_{0.5}Mn_{1.5}O₄; LiFePO₄, LiMnPO₄, LiCoPO₄, and LiVPO₄F.

In one embodiment, the electroactive compound includes LiₐNi_{b}Mn_{c}Co_{d}RₑO_{2-f}Z_{f} as defined above with the exceptions that 0.1≦b≦0.5 and also 0.2≦c≦0.7.

In the above chemical formulas A is Ni, Co, Mn, or a combination thereof; D is O, F, S, P, or a combination thereof; E is Co, Mn, or a combination thereof; G is Al, Cr, Mn, Fe, Mg, La, Ce, Sr, V, or a combination thereof; R is Al, Ni, Co, Mn, Cr, Fe, Mg, Sr, V, Zr, Ti, a rare earth element, or a combination thereof; Z is F, S, P, or a combination thereof. Suitable cathodes and cathode active materials include those disclosed in U.S. Pat. Nos. 5,962,166; 6,680,145; 6,964,828; 7,026,070; 7,078,128; 7,303,840; 7,381,496; 7,468,223; 7,541,114; 7,718,319; 7,981,544; 8,389,160; 8,394,534; and 8,535,832, and the references therein. By “rare earth element” is meant the lanthanide elements from La to Lu, and Y and Sc. In another embodiment the cathode material is an NMC cathode; that is, a LiNiMnCoO cathode. More specifically, cathodes in which the atomic ratio of Ni:Mn:Co is 1:1:1 (LiₐNi_{1-b-c}Co_{b}R_{c}O_{2-d}Z_{d} where 0.98≦a≦1.05, 0≦d≦0.05, b=0.333, c=0.333, where R comprises Mn) or where the atomic ratio of Ni:Mn:Co is 5:3:2 (LiₐNi_{1-b-c}Co_{b}R_{c}O_{2-d}Z_{d} where 0.98≦a≦1.05, 0≦d≦0.05, c=0.3, b=0.2, where R comprises Mn).

In another embodiment, the positive electrode in the lithium ion battery disclosed herein comprises a positive electrode active material comprising composite material of the formula LiₐMn_{b}J_{c}O₄Z_{d}, wherein J is Ni, Co, Mn, Cr, Fe, Cu, V, Ti, Zr, Mo, B, Al, Ga, Si, Li, Mg, Ca, Sr, Zn, Sn, a rare earth element, or a combination thereof; Z is F, S, P, or a combination thereof; and 0.9≦a≦1.2, 1.3≦b≦2.2, 0≦c≦0.7, 0≦d≦0.4.

In another embodiment, the positive electrode in the lithium ion battery disclosed herein comprises a positive electrode active material exhibiting greater than 30 mAh/g capacity in the potential range greater than 4.6 V versus a Li/Li⁺ reference electrode. One example of such a positive electrode is a stabilized manganese positive electrode comprising a lithium-containing manganese composite oxide having a spinel structure as positive electrode active material. The lithium-containing manganese composite oxide in a cathode suitable for use herein comprises oxides of the formula LiₓNi_{y}M_{z}Mn_{2-y-z}O_{4-d}, wherein x is 0.03 to 1.0; x changes in accordance with release and uptake of lithium ions and electrons during charge and discharge; y is 0.3 to 0.6; M comprises one or more of Cr, Fe, Co, Li, Al, Ga, Nb, Mo, Ti, Zr, Mg, Zn, V, and Cu; z is 0.01 to 0.18; and d is 0 to 0.3. In one embodiment in the above formula, y is 0.38 to 0.48, z is 0.03 to 0.12, and d is 0 to 0.1. In one embodiment in the above formula, M is one or more of Li, Cr, Fe, Co and Ga. Stabilized manganese cathodes may also comprise spinel-layered composites which contain a manganese-containing spinel component and a lithium rich layered structure, as described in U.S. Pat. No. 7,303,840.

In another embodiment, the positive electrode material in the lithium ion battery disclosed herein comprises a composite material represented by the formula:

x(Li_{2-w}A₁₋ᵥQ_{w+v}O₃₋ₑ)*(1−x)(Li_{y}Mn_{2-z}M_{z}O_{4-d})

wherein:

x is about 0.005 to about 0.1;

A comprises one or more of Mn or Ti;

Q comprises one or more of Al, Ca, Co, Cr, Cu, Fe, Ga, Mg, Nb, Ni, Ti, V, Zn, Zr or Y;

e is 0 to about 0.3;

v is 0 to about 0.5.

w is 0 to about 0.6;

M comprises one or more of Al, Ca, Co, Cr, Cu, Fe, Ga, Li, Mg, Mn, Nb, Ni, Si, Ti, V, Zn, Zr or Y;

d is 0 to about 0.5;

y is about 0 to about 1;

z is about 0.3 to about 1; and

wherein the Li_{y}Mn_{2-z}M_{z}O_{4-d} component has a spinel structure and the Li_{2-w}Q_{w+v}A₁₋ᵥO₃₋ₑ component has a layered structure.

Alternatively, in another embodiment, in the Formula

x(Li_{2-w}A₁₋ᵥQ_{w+v}O₃₋ₑ)*(1−x)(Li_{y}Mn_{2-z}M_{z}O_{4-d})

x is about 0 to about 0.1, and all ranges for the other variables are as stated above.

In another embodiment, the positive electrode in the lithium ion battery disclosed herein comprises a composition of the formula

LiₐA₁₋ₓRₓDO_{4-f}Z_{f},

wherein:

A is Fe, Mn, Ni, Co, V, or a combination thereof;

R is Al, Ni, Co, Mn, Cr, Fe, Mg, Sr, V, Zr, Ti, a rare earth element, or a combination thereof;

D is P, S, Si, or a combination thereof;

Z is F, Cl, S, or a combination thereof;

0.8≦a≦2.2;

0≦x≦0.3; and

0≦f≦0.1.

In another embodiment, the positive electrode in the lithium ion battery disclosed herein comprises a positive electrode active material which is charged to a potential greater than or equal to about 4.1 V, or greater than 4.35 V, or greater than 4.5 V, or greater than 4.6 V versus a Li/Li⁺ reference electrode. Other examples are layered-layered high-capacity oxygen-release cathodes such as those described in U.S. Pat. No. 7,468,223 charged to upper charging potentials above 4.5 V.

A positive electrode active material suitable for use herein can be prepared using methods such as the hydroxide precursor method described by Liu et al (J. Phys. Chem. C 13:15073-15079, 2009). In that method, hydroxide precursors are precipitated from a solution containing the required amounts of manganese, nickel and other desired metal(s) acetates by the addition of KOH. The resulting precipitate is oven-dried and then fired with the required amount of LiOH*H₂0 at about 800 to about 1000° C. in oxygen for 3 to 24 hours. Alternatively, the positive electrode active material can be prepared using a solid phase reaction process or a sol-gel process as described in U.S. Pat. No. 5,738,957 (Amine).

A cathode, in which the positive electrode active material is contained, suitable for use herein may be prepared by methods such as mixing an effective amount of the positive electrode active material (e.g. about 70 wt % to about 97 wt %), a polymer binder, such as polyvinylidene difluoride, and conductive carbon in a suitable solvent, such as N-methylpyrrolidone, to generate a paste, which is then coated onto a current collector such as aluminum foil, and dried to form the cathode.

The electrode comprising the compositions described herein may be prepared using methods known in the art. For example, the electrode may be prepared by mixing an effective amount of the compositions described herein (e.g., about 70-96 wt %), a polymer binder, such as polyvinylidene difluoride, and conductive carbon in a suitable solvent, such as N-methylpyrrolidone, to generate a paste, which is coated onto a current collector, such as aluminum foil, and dried to form the positive electrode.

Disclosed herein is an electrochemical cell comprising the electrodes described above. It can have a positive electrode with an upper charging voltage greater than about 4.4, or 4.6, or 4.8 V. The cell comprises a housing, a negative electrode and a positive electrode disposed in the housing and in ionically conductive contact with one another, an electrolyte composition, providing an ionically conductive pathway between the negative electrode and the positive electrode, and a porous separator between the negative electrode and the positive electrode. In one embodiment, the polyimide separator is facing the positive electrode.

The housing may be any suitable container to house the electrochemical cell components. The negative electrode may be comprised of any suitable conducting material depending on the type of electrochemical cell. Suitable examples of negative electrode materials include, but are not limited to, lithium metal, lithium metal alloys, aluminum, platinum, palladium, graphite, transition metal oxides, and lithiated tin oxide. The porous separator serves to prevent short circuiting between the negative electrode and the positive electrode. The porous separator typically consists of a single-ply or multi-ply sheet of a microporous polymer. The pore size of the porous separator is sufficiently large to permit transport of ions, but small enough to prevent contact of the negative electrode and positive electrode either directly or from particle penetration or dendrites which can form on the negative electrode and positive electrode.

In one embodiment, the electrochemical cell is a lithium ion battery. The lithium ion battery can retain greater than 50% of its capacity when cycled for 300 cycles at a rate between 0.4C and 2C at a temperature of 55° C.

A lithium ion battery as disclosed herein can further contain a negative electrode, which comprises a negative electrode active material that is capable of storing and releasing lithium ions. Examples of suitable negative electrode active materials include without limitation silicon, lithium metal, lithium alloys such as lithium-aluminum alloy, lithium-lead alloy, lithium-silicon alloy, lithium-tin alloy and the like; carbon materials such as graphite and mesocarbon microbeads (MCMB); phosphorus-containing materials such as black phosphorus, MnP₄ and CoP₃, metal oxides such as SnO₂, SnO and TiO₂, nanocomposites containing antimony or tin, for example nanocomposites containing antimony, oxides of aluminum, titanium, or molybdenum, and carbon, such as those described by Yoon et al (Chem. Mater. 21, 3898-3904, 2009); and lithium titanates such as Li₄Ti₅O₁₂ and LiTi₂O₄. In one embodiment, the negative electrode active material is lithium titanate, graphite, lithium alloys, silicon, and combinations thereof. In one embodiment, the negative electrode material comprises at least one of carbon, graphite, lithium titanates, lithium-tin alloys, silicon, or mixtures thereof. In one embodiment, the negative electrode active material is lithium titanate. In another embodiment, the negative electrode active material is graphite.

An anode, in which the negative electrode active material is contained, can be made by a method similar to that described above for a cathode wherein, for example, a binder such as a vinylidene fluoride-based copolymer is dissolved or dispersed in an organic solvent or water, which is then mixed with the active, conductive material to obtain a paste. The paste is coated onto a metal foil, preferably aluminum or copper foil, to be used as the current collector. The paste is dried, preferably with heat, so that the active mass is bonded to the current collector. Suitable negative electrode active materials and anodes are available commercially from companies such as Hitachi NEI Inc. (Somerset, N.J.), and Farasis Energy Inc. (Hayward, Calif.).

The lithium ion battery hereof further contains a nonaqueous electrolyte composition, which is a chemical composition suitable for use as an electrolyte in a lithium ion battery. The electrolyte composition typically contains at least one nonaqueous solvent and at least one electrolyte salt. The electrolyte salt is an ionic salt that is at least partially soluble in the solvent of the nonaqueous electrolyte composition and that at least partially dissociates into ions in the solvent of the nonaqueous electrolyte composition to form a conductive electrolyte composition. The conductive electrolyte composition puts the positive electrode and negative electrode in ionically conductive contact with one another such that ions, in particular lithium ions, are free to move between the negative electrode and the positive electrode and thereby conduct charge through the electrolyte composition between the negative electrode and the positive electrode. Suitable electrolyte salts include without limitation:

lithium hexafluorophosphate,

lithium bis(trifluromethyl)tetrafluorophosphate (LiPF₄(CF₃)₂),

lithium bis(pentafluoroethyl)tetrafluorophosphate (LiPF₄(C₂F₅)₂),

lithium tris(pentafluoroethyl)trifluorophosphate Li PF₃(CF₂CF₃)₃,

lithium bis(trifluoromethanesulfonyl)imide,

lithium bis(perfluoroethanesulfonyl)imide,

lithium (fluorosulfonyl)

(nonafluorobutanesulfonyl)imide,

lithium bis(fluorosulfonyl)imide,

lithium tetrafluoroborate,

lithium perchlorate,

lithium hexafluoroarsenate,

lithium trifluoromethanesulfonate,

lithium tris(trifluoromethanesulfonyl)methide,

lithium bis(oxalato)borate,

lithium difluoro(oxalato)borate,

Li₂B₁₂F₁₂₋ₓHₓ where x is equal to 0 to 8, and

mixtures of lithium fluoride and anion receptors such as B(OC₆F₅)₃.

Mixtures of two or more of these or comparable electrolyte salts may also be used. In one embodiment, the electrolyte salt is lithium hexafluorophosphate. The electrolyte salt can be present in the electrolyte composition in an amount of about 0.2 to about 2.0 M, more particularly about 0.3 to about 1.5 M, and more particularly about 0.5 to about 1.2 M.

The electrolyte composition can comprise at least one electrolyte salt and greater than about 20 weight percent of at least one fluorinated solvent. Any suitable electrolyte solvents can be used, such as but not limited to ethylene carbonate, propylene carbonate, butylene carbonate, diethyl carbonate, dimethyl carbonate, ethyl methyl carbonate and 1,2-dimethoxyethane. Other suitable electrolyte solvents are fluorinated solvents such as, but not limited to, fluorinated acyclic carboxylic acid esters, fluorinated acyclic carbonates, fluorinated acyclic ethers, fluorinated ethers, fluorinated cyclic carbonates, and fluorine-containing carboxylic acid esters. In one embodiment, the electrolyte composition comprises at least one electrolyte salt and greater than about 20 weight percent of at least one fluorinated acyclic carboxylic acid ester, fluorinated acyclic carbonate, fluorinated acyclic ether, fluorinated ether, fluorinated cyclic carbonate, or fluorine-containing carboxylic acid ester. Suitable electrolyte solvents are described in published patent applications WO 2013/033595 A1 and WO 2013/180783 A1, for example.

Suitable fluorinated acyclic carboxylic acid esters are represented by the formula

R¹—COO—R²

wherein

i) R¹ is H, an alkyl group, or a fluoroalkyl group;

ii) R² is an alkyl group or a fluoroalkyl group;

iii) either or both of R¹ and R² comprises fluorine; and

iv) R¹ and R², taken as a pair, comprise at least two carbon atoms but not more than seven carbon atoms.

In one embodiment, R¹ is H and R² is a fluoroalkyl group. In one embodiment, R¹ is an alkyl group and R² is a fluoroalkyl group. In one embodiment, R¹ is a fluoroalkyl group and R² is an alkyl group. In one embodiment, R¹ is a fluoroalkyl group and R² is a fluoroalkyl group, and R¹ and R² can be either the same as or different from each other. In one embodiment, R¹ comprises one carbon atom. In one embodiment, R¹ comprises two carbon atoms.

In another embodiment, R¹ and R² are as defined herein above, and R¹ and R², taken as a pair, comprise at least two carbon atoms but not more than seven carbon atoms and further comprise at least two fluorine atoms, with the proviso that neither R¹ nor R² contains a FCH₂— group or a —FCH— group.

In one embodiment, the number of carbon atoms in R¹ in the formula above is 1, 3, 4, or 5.

In one embodiment, the fluorinated acyclic carboxylic acid ester can be a compound represented by the formula R′—COO—R², wherein R¹ is selected from the group consisting of CH₃, CH₂CH₃, CH₂CH₂CH₃, CH(CH₃)₂, CF₃, CF₂H, CFH₂, CF₂R₇, CFHR₇, and CH₂R_{f}, and R² is independently selected from the group consisting of CH₃, CH₂CH₃, CH₂CH₂CH₃, CH(CH₃)₂, and CH₂R_{f}, where R₇ is a C₁ to C₃ alkyl group which is optionally substituted with at least one fluorine, and R_{f} is a C₁ to C₃ alkyl group substituted with at least one fluorine, and further wherein at least one of R¹ or R² contains at least one fluorine and when R¹ is CF₂H, R² is not CH₃

Examples of suitable fluorinated acyclic carboxylic acid esters include without limitation CH₃—COO—CH₂CF₂H (2,2-difluoroethyl acetate, CAS No. 1550-44-3), CH₃—COO—CH₂CF₃ (2,2,2-trifluoroethyl acetate, CAS No. 406-95-1), CH₃CH₂—COO—CH₂CF₂H (2,2-difluoroethyl propionate, CAS No. 1133129-90-4), CH₃—COO—CH₂CH₂CF₂H (3,3-difluoropropyl acetate), CH₃CH₂—COO—CH₂CH₂CF₂H (3,3-difluoropropyl propionate), HCF₂—CH₂—CH₂—COO—CH₂CH₃ (ethyl 4,4-difluorobutanoate, CAS No. 1240725-43-2), CH₃—COO—CH₂CF₃ (2,2,2-trifluoroethyl acetate, CAS No. 406-95-1), H—COO—CH₂CF₂H (difluoroethyl formate, CAS No. 1137875-58-1), H—COO—CH₂CF₃ (trifluoroethyl formate, CAS No. 32042-38-9), and mixtures thereof. In one embodiment, the fluorinated acyclic carboxylic acid ester comprises 2,2-difluoroethyl acetate (CH₃—COO—CH₂CF₂H). In one embodiment, the fluorinated acyclic carboxylic acid ester comprises 2,2-difluoroethyl propionate (CH₃CH₂—COO—CH₂CF₂H). In one embodiment, the fluorinated acyclic carboxylic acid ester comprises 2,2,2-trifluoroethyl acetate (CH₃—COO—CH₂CF₃). In one embodiment, the fluorinated acyclic carboxylic acid ester comprises 2,2-difluoroethyl formate (H—COO—CH₂CF₂H).

Suitable fluorinated acyclic carbonates are represented by the formula:

R³—OCOO—R⁴

wherein

i) R³ is a fluoroalkyl group;

ii) R⁴ is an alkyl group or a fluoroalkyl group; and

iii) R³ and R⁴ taken as a pair comprise at least two carbon atoms but not more than seven carbon atoms.

In one embodiment, R³ is a fluoroalkyl group and R⁴ is an alkyl group. In one embodiment, R³ is a fluoroalkyl group and R⁴ is a fluoroalkyl group, and R³ and R⁴ can be either the same as or different from each other. In one embodiment, R³ and R⁴ independently can be branched or linear. In one embodiment, R³ comprises one carbon atom. In one embodiment, R³ comprises two carbon atoms.

In another embodiment, R³ and R⁴ are as defined herein above, and R³ and R⁴, taken as a pair, comprise at least two carbon atoms but not more than seven carbon atoms and further comprise at least two fluorine atoms, with the proviso that neither R³ nor R⁴ contains a FCH₂— group or a —FCH— group.

In one embodiment, the fluorinated acyclic carbonate can be a compound represented by the formula R³—OCOO—R⁴, wherein R³ and R⁴ are independently selected from the group consisting of CH₃, CH₂CH₃, CH₂CH₂CH₃, CH(CH₃)₂, and CH₂R_{f} where R_{f} is a C₁ to C₃ alkyl group substituted with at least one fluorine, and further wherein at least one of R³ or R⁴ contains at least one fluorine.

Examples of suitable fluorinated acyclic carbonates include without limitation CH₃—OC(O)O—CH₂CF₂H (methyl 2,2-difluoroethyl carbonate, CAS No. 916678-13-2), CH₃—OC(O)O—CH₂CF₃ (methyl 2,2,2-trifluoroethyl carbonate, CAS No. 156783-95-8), CH₃—OC(O)O—CH₂CF₂CF₂H (methyl 2,2,3,3-tetrafluoropropyl carbonate, CAS No. 156783-98-1), HCF₂CH₂—OCOO—CH₂CH₃ (2,2-difluoroethyl ethyl carbonate, CAS No. 916678-14-3), and CF₃CH₂—OCOO—CH₂CH₃ (2,2,2-trifluoroethyl ethyl carbonate, CAS No. 156783-96-9).

Suitable fluorinated acyclic ethers are represented by the formula:

R⁵—O—R⁶

wherein

i) R⁵ is a fluoroalkyl group;

ii) R⁶ is an alkyl group or a fluoroalkyl group; and

iii) R⁵ and R⁶ taken as a pair comprise at least two carbon atoms but not more than seven carbon atoms.

In one embodiment, R⁵ is a fluoroalkyl group and R⁶ is an alkyl group. In one embodiment, R⁵ is a fluoroalkyl group and R⁶ is a fluoroalkyl group, and R⁵ and R⁶ can be either the same as or different from each other. In one embodiment, R⁵ and R⁶ independently can be branched or linear. In one embodiment, R⁵ comprises one carbon atom. In one embodiment, R⁵ comprises two carbon atoms.

In another embodiment, R⁵ and R⁶ are as defined herein above, and R⁵ and R⁶, taken as a pair, comprise at least two carbon atoms but not more than seven carbon atoms and further comprise at least two fluorine atoms, with the proviso that neither R⁵ nor R⁶ contains a FCH₂— group or a —FCH— group.

Examples of suitable fluorinated acyclic ethers include without limitation HCF₂CF₂CH₂—O—CF₂CF₂H (CAS No. 16627-68-2) and HCF₂CH₂—O—CF₂CF₂H (CAS No. 50807-77-7).

A mixture of two or more fluorinated solvents may also be used. As used herein, the term “mixtures” encompasses both mixtures within and mixtures between solvent classes, for example mixtures of two or more fluorinated acyclic carboxylic acid esters, and also mixtures of fluorinated acyclic carboxylic acid esters and fluorinated acyclic carbonates, for example. Non-limiting examples include a mixture of 2,2-difluoroethyl acetate and 2,2-difluoroethyl propionate, or a mixture of 2,2-difluoroethyl acetate and 2,2 difluoroethyl methyl carbonate.

In one embodiment, the fluorinated solvent is:
a) a fluorinated acyclic carboxylic acid ester represented by the formula:

R¹—COO—R²,
b) a fluorinated acyclic carbonate represented by the formula:

R³—OCOO—R⁴,
c) a fluorinated acyclic ether represented by the formula:

R⁵—O—R⁶,
or mixtures thereof;
   wherein
i) R¹ is H, an alkyl group, or a fluoroalkyl group;
ii) R³ and R⁵ is each independently a fluoroalkyl group and can be either the same as or different from each other;
iii) R², R⁴, and R⁶ is each independently an alkyl group or a fluoroalkyl group and can be either the same as or different from each other;
iv) either or both of R¹ and R² comprises fluorine; and
v) R¹ and R², R³ and R⁴, and R⁵ and R⁶, each taken as a pair, comprise at least two carbon atoms but not more than seven carbon atoms.

In another embodiment, the fluorinated solvent is
a) a fluorinated acyclic carboxylic acid ester represented by the formula:

R¹—COO—R²,
b) a fluorinated acyclic carbonate represented by the formula:

R³—OCOO—R⁴,
c) a fluorinated acyclic ether represented by the formula:

R⁵—O—R⁶,
or mixtures thereof;
   wherein
i) R¹ is H, an alkyl group, or a fluoroalkyl group;
ii) R³ and R⁵ is each independently a fluoroalkyl group and can be either the same as or different from each other;
iii) R², R⁴, and R⁶ is each independently an alkyl group or a fluoroalkyl group and can be either the same as or different from each other;
iv) either or both of R¹ and R² comprises fluorine; and
v) R¹ and R², R³ and R⁴, and R⁵ and R⁶, each taken as a pair, comprise at least two carbon atoms but not more than seven carbon atoms and further comprise at least two fluorine atoms, with the proviso that none of R¹, R², R³, R⁴, R⁵, nor R⁶ contains a FCH₂— group or a —FCH— group.

In one embodiment, the fluorinated solvent comprises a fluorinated cyclic carbonate represented by the structure:

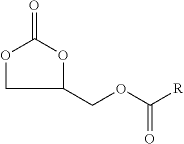

wherein R is a C₁ to C₄ fluoroalkyl group. In one embodiment, the cyclic carbonate compound is (2-oxo-1,3-dioxolan-4-yl)methyl 2,2,2-trifluoroacetate, wherein R in the structure above is CF₃. In another embodiment, the cyclic carbonate compound is (2-oxo-1,3-dioxolan-4-yl)methyl 2,2-difluoroacetate, wherein R in the structure above is CF₂H. Fluorinated cyclic carbonates represented by the structure above can be prepared as disclosed in U.S. Pat. No. 8,735,005.

In another embodiment, suitable fluorinated cyclic carbonates can be represented by the following structure

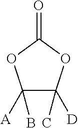

wherein

i) each of A, B, C, and D is H, F, a saturated or unsaturated C₁ to C₄ alkyl group, or a saturated or unsaturated C₁ to C₄ fluoroalkyl group, and can be the same as or different from each other; and

ii) at least one of A, B, C, and D comprises fluorine.

The term “unsaturated”, as used herein, refers to an olefinically unsaturated group containing at least one carbon-carbon double bond.

Suitable fluorinated carbonates include 4-fluoroethylene carbonate (abbreviated as FEC, also known as 4-fluoro-1,3-dioxolan-2-one), difluoroethylene carbonate isomers, trifluoroethylene carbonate isomers, tetrafluoroethylene carbonate, 2,2,3,3-tetrafluoropropyl methyl carbonate, bis(2,2,3,3-tetrafluoropropyl) carbonate, bis(2,2,2-trifluoroethyl) carbonate, 2,2,2-trifluoroethyl methyl carbonate, bis(2,2-difluoroethyl) carbonate, 2,2-difluoroethyl methyl carbonate, or methyl 2,3,3-trifluoroallyl carbonate, or mixtures thereof. In one embodiment the fluorinated carbonate comprises fluoroethylene carbonate. In one embodiment, the fluorinated carbonate comprises 4-fluoro-1,3-dioxolan-2-one; 4,5-difluoro-1,3-dioxolan-2-one; 4,5-difluoro-4-methyl-1,3-dioxolan-2-one; 4,5-difluoro-4,5-dimethyl-1,3-dioxolan-2-one; 4,4-difluoro-1,3-dioxolan-2-one; 4,4,5-trifluoro-1,3-dioxolan-2-one; or mixtures thereof.

For best results, it is desirable to use an electrolyte solvent that has a purity of at least about 99.9%, for example at least about 99.99%. Electrolyte solvents may be purified using distillation methods known in the art. Electrolyte solvents are available commerically or may be prepared by methods known in the art.

Electrolyte compositions disclosed herein can additionally or optionally comprise additives that are known to those of ordinary skill in the art to be useful in conventional electrolyte compositions, particularly for use in lithium ion batteries. For example, electrolyte compositions disclosed herein can also include gas-reduction additives which are useful for reducing the amount of gas generated during charging and discharging of lithium ion batteries. Gas-reduction additives can be used in any effective amount, but can be included to comprise from about 0.05 weight % to about 10 weight %, alternatively from about 0.05 weight % to about 5 weight % of the electrolyte composition, or alternatively from about 0.5 weight % to about 2 weight % of the electrolyte composition.

Suitable gas-reduction additives that are known conventionally are, for example: halobenzenes such as fluorobenzene, chlorobenzene, bromobenzene, iodobenzene, or haloalkylbenzenes; succinic anhydride; ethynyl sulfonyl benzene; 2-sulfobenzoic acid cyclic anhydride; divinyl sulfone; triphenylphosphate (TPP); diphenyl monobutyl phosphate (DMP); γ-butyrolactone; 2,3-dichloro-1,4-naphthoquinone; 1,2-naphthoquinone; 2,3-dibromo-1,4-naphthoquinone; 3-bromo-1,2-naphthoquinone; 2-acetylfuran; 2-acetyl-5-methylfuran; 2-methyl imidazole1-(phenylsulfonyl)pyrrole; 2,3-benzofuran; fluoro-cyclotriphosphazenes such as 2,4,6-trifluoro-2-phenoxy-4,6-dipropoxy-cyclotriphosphazene and 2,4,6-trifluoro-2-(3-(trifluoromethyl)phenoxy)-6-ethoxy-cyclotriphosphazene; benzotriazole; perfluoroethylene carbonate; anisole; diethylphosphonate; fluoroalkyl-substituted dioxolanes such as 2-trifluoromethyldioxolane and 2,2-bistrifluoromethyl-1,3-dioxolane; trimethylene borate; dihydro-3-hydroxy-4,5,5-trimethyl-2(3H)-furanone; dihydro-2-methoxy-5,5-dimethyl-3(2H)-furanone; dihydro-5,5-dimethyl-2,3-furandione; propene sultone; diglycolic acid anhydride; di-2-propynyl oxalate; 4-hydroxy-3-pentenoic acid γ-lactone; CF₃COOCH₂C(CH₃)(CH₂OCOCF₃)₂; CF₃COOCH₂CF₂CF₂CF₂CF₂CH₂OCOCF₃; α-methylene-γ-butyrolactone; 3-methyl-2(5H)-furanone; 5,6-dihydro-2-pyranone; diethylene glycol, diacetate; triethylene glycol dimethacrylate; triglycol diacetate; 1,2-ethanedisulfonic anhydride; 1,3-propanedisulfonic anhydride; 2,2,7,7-tetraoxide 1,2,7-oxadithiepane; 3-methyl-, 2,2,5,5-tetraoxide 1,2,5-oxadithiolane; hexamethoxycyclotriphosphazene; 4,5-dimethyl-4,5-difluoro-1,3-dioxolan-2-one; 2-ethoxy-2,4,4,6,6-pentafluoro-2,2,4,4,6,6-hexahydro-1,3,5,2,4,6-triazatriphosphorine; 2,2,4,4,6-pentafluoro-2,2,4,4, 6,6-hexahydro-6-methoxy-1,3,5,2,4,6-triazatriphosphorine; 4,5-difluoro-1,3-dioxolan-2-one; 1,4-bis(ethenylsulfonyl)-butane; bis(vinylsulfonyl)-methane; 1,3-bis(ethenylsulfonyl)-propane; 1,2-bis(ethenylsulfonyl)-ethane; and 1,1′-[oxybis(methylenesulfonyl)]bis-ethene.

Other suitable additives that can be used are HF scavengers, such as silanes, silazanes (Si—NH—Si), epoxides, amines, aziridines (containing two carbons), salts of carbonic acid such as lithium oxalate, B₂O₅, ZnO, and fluorinated inorganic salts.

The electrolyte compositions disclosed herein are useful in many types of electrochemical cells and batteries such as capacitors, nonaqueous batteries such as lithium batteries, flow batteries, and fuel cells.

The electrochemical cells and lithium ion battery disclosed herein may be used in a variety of applications. For example, the electrochemical cell may be used for grid storage or as a power source in various electronically-powered or -assisted devices, such as a computer, a camera, a radio, a power tool, a telecommunications device, or a transportation device (including a motor vehicle, automobile, truck, bus or airplane). The present disclosure also relates to an electronic device, a telecommunications device, or a transportation device comprising the disclosed electrochemical cell.

### Examples

### Test Methods

Mean flow pore size was measured according to ASTM Designation E 1294-89, “Standard Test Method for Pore Size Characteristics of Membrane Filters Using Automated Liquid Porosimeter” incorporated herein by reference in its entirety. A capillary Flow Porometer CFP-2100AE (Porous Materials Inc. Ithaca, N.Y.) was used. Individual samples of 25 mm diameter were wetted with a low surface tension fluid (1,1,2,3,3,3-hexafluoropropene, or “Galwick,” having a surface tension of 16 dyne/cm) and placed in a holder, and a differential pressure of air was applied and the fluid removed from the sample. The differential pressure at which wet flow is equal to one-half the dry flow (flow without wetting solvent) was used to calculate the mean flow pore size using supplied software.

Thickness was determined using a handheld micrometer (Mitutoyo APB-2D, Mitutoyo America Corporation, Aurora, Ill.) having 6 mm diameter spindles and applies a pressure of 75 kPa. Thickness is reported in micrometers (μm).

Basis weight was determined according to ASTM D-3776 and reported in g/m² (GSM).

Porosity was calculated by dividing the basis weight of the sample in GSM by the polymer density in GSM and by the sample thickness in micrometers and multiplying by 100 and subsequently subtracting from 100%, i.e., percent porosity=100−basis weight/(density×thickness)×100.

The air permeability was measured according to ASTM Designation D726-94, “Standard Test Method for Resistance of Nonporous Paper to Passage of Air”. Individual samples were placed in the holder of Automatic Densometer model 4340 (Gurley Precision Instruments, Troy, N.Y.) and an air at a pressure of 0.304 (kPa) was forced through an area of 0.1 inch² or 0.645 cm² of the sample, recalculated by software to 1 inch² or 6.45 cm². The time in seconds required for 100 (cm³) of air to pass through the sample was recorded as the Gurley air permeability with the units of (s/100 cm³ or s/100 cc).

Ionic Resistance is a measure of a separator's resistance to the flow of ions, and is measured using an AC impedance technique. Samples were cut into small pieces (31.75 cm diameter) and soaked in 1M LiPF₆ in 30:70 ethylene carbonate/ethyl methyl carbonate (EC/EMC) electrolyte. The separator resistance was measured using Solartron 1287 Electrochemical Interface along with Solartron 1252 Frequency Response Analyzer and Scribner Associates Zplot (version 3.1c) software. The test cell had a 5.067 cm² electrode area that contacted the wetted separator. Measurements were done at AC amplitude of 5 mV and the frequency range of 10 Hz to 100,000 Hz. The high frequency intercept in the Nyquist plot is the separator resistance (in ohm). The separator resistance (ohm) was multiplied with the electrode area (5.067 square cm) to determine ionic resistance in ohm-cm².

MacMullin Number (Nm) is a dimensionless number and is a measure of the ionic resistance of the separator. It is defined as the ratio of the resistivity of a separator sample filled with electrolyte to the resistivity of an equivalent volume of the electrolyte alone. It is expressed by:

Nm=(RseparatorxAelectrode)/(pelectrolytextseparator) where “Rseparator” is the resistance of the separator in ohms, “Aelectrode” is the area of electrode in cm², “pelectrolyte” is the resistivity of electrolyte in ohm*cm, and “tseparator” is the thickness of separator in cm.

“Tensile strength” as used herein refers to the test according to ISO 9073-3. Tensile strength was determined for samples cut into 50×250 mm strips and pulled until breaking in a tensile testing machine at a rate of 50 mm/min with a gauge length of 200 mm.

### Examples 1-2 and Comparative Examples 1-3

Aluminum treatment: A 24% copolymer dispersion in water was obtained from Dow Chemical (Midland Mich.) as Adcote™ 50C12 (formerly produced by Rohm & Haas). Lithium polysilicate 20% in water was obtained from Sigma Aldrich (St. Louis, Mo.). A mixture containing 8.6% of three solids in the weight ratios of 31:36:33 Adcote™:lithium polysilicate:carbon black was made using:
11.11 g Adcote™ dispersion
15.48 g lithium polysilicate
2.84 g carbon black C•Nergy™ Super C65 (Timcal, Westlake, Ohio) 70.57 g water

The water and carbon black were combined in an Erlenmeyer flask and mixed at 600 rpm for 5 minutes using a magnetic stir bar. Then the lithium polysilicate and Adcote™ were added and stirred further. The mixture was sprayed with an air brush on to aluminum foil (25 μm thick, 1145-0, Allfoils, Brooklyn Heights, Ohio) to a coating weight of 0.5 mg/cm². The coating was dried in a vacuum oven at 60° C.

Positive electrode Preparation: LiNi_{0.5}Mn_{1.5}O₄ (LNMO) spinel positive electrode powder was obtained from NEI Corporation (Nanomyte™ SP-10, Somerset, N.J.). A dispersion of 15% carbon black (C•Nergy™ Super C65) in N-methyl-pyrrolidinone (NMP) was prepared by mixing the carbon black and NMP for 60 seconds at 2000 rpm using a planetary centrifugal mixer (ARE-310, Thinky USA, Inc., Laguna Hills, Calif.). The binder was obtained as a 12% solution of polyvinylidene fluoride (PVDF) in NMP (KFL #1120, Kureha America Corp NY, N.Y.). The following were used to make an electrode paste:

5.88 g LNMO

5.84 g PVDF solution

2.80 g wetted carbon black

5.48 g NMP

The carbon black and PVDF solution were first combined and centrifugally mixed for 60 sec at 2000 rpm. The LNMO powder, along with the additional NMP, were added to the carbon black and PVDF mixture, and the paste centrifugally mixed for 120 sec at 2000 rpm. The paste was cast using a doctor blade with a 0.38 mm gate height onto the treated aluminum foil. The electrode paste was dried in a vacuum oven with a nitrogen bleed at 120° C. for 40 minutes. After removal of NMP, the positive electrode consisted of 84% LNMO, 10% binder, 6% carbon black. The LNMO loading was about 12 mg/cm².

Negative electrode Preparation: The following were used to make the negative electrode paste:
5.60 g Li₄Ti₅O₁₂ (LTO, Nanomyte™ BE-10, NEI Corporation)
5.83 g PVDF solution, 12% in NMP (KFL #1120, Kureha America Corp)
4.67 g C•Nergy™ Super C65 carbon black 15% dispersion in NMP 3.90 g NMP

The carbon black dispersion and PVDF solution were first combined and centrifugally mixed for 60 s at 2000 rpm. The LTO powder, along with the additional NMP, were added to the carbon black and PVDF mixture, and the paste centrifugally mixed for 120 s at 2000 rpm. The paste was cast using a doctor blade with a 0.38 mm gate height onto untreated aluminum foil. The electrode paste was dried in a vacuum oven with a nitrogen bleed at 120° C. for 40 minutes. After removal of NMP, the negative electrode consisted of 80:10:10 LTO:PVDF:Carbon Black. The loading of LTO was about 13 mg/cm².

Coin Cells: Circular negative electrodes and positive electrodes were punched out to 14.3 mm diameter, and placed in a heater in the antechamber of a glove box, further dried under vacuum overnight at 100° C., and brought in to an argon glove box (Vacuum Atmospheres, Hawthorne, Calif., with HE-493 purifier). Nonaqueous electrolyte lithium-ion CR2032 coin cells were prepared for electrochemical evaluation. The coin cell parts (case, spacer, wave spring, gasket, and lid) and coin cell crimper were obtained from Hohsen Corp (Osaka, Japan).

Comparative Examples 1 and 3 used a 40 micrometer thick microporous polyolefin separator (CG2340, Celgard™ 2340, Charlotte, N.C.). Comparative Example 2 used a 20 micrometer thick microporous polyolefin separator (CG2320, Celgard™ 2320, Charlotte, N.C.). Examples 1 and 2 used the polyimide based nanofiber (Pl-NF) separators described below.

An electroblowing process and apparatus for forming a nanofiber web as disclosed in WO 2003/080905 was used to produce the nanofiber layers and webs of Examples 1 and 2. Polyamic acid webs were prepared from a solution of PMDA/ODA in dimethyl formamide (DMF) and electroblown using the electroblowing process and apparatus for forming a nanofiber web as described in WO 2003/080905. The polyamic acid webs were than calendered through a steel/cotton nip at 650 pli and 25° C. followed by a heat treatment according to the procedure described in published US Patent Application No. 2011/0144297, which is incorporated herein by reference in its entirety. Table 1 below summarizes the properties of the resulting nanoweb used for Examples 1 and 2. All nanowebs were composed of fully imidized polyimide fibers having an average fiber size, as measured using scanning electron microscopy, between 600 and 800 nm.

TABLE 1
Properties of Nanoweb Used for Examples 1 and 2.

| Property | Units | Value |
|---|---|---|
| Basis Weight | GSM (g/m²) | 14.4 |
| Thickness | Micrometer | 23 |
| Porosity | % | 56.2 |
| Gurley | Sec/100 cc | 1.6 |
| Mean Flow Pore | Micrometer | 1.24 |
| Resistance | Ohms-cm² | 0.95 |
| MacMullen No. | | 3.5 |

The electrolyte used was 1 M LiPF₆ in 37:63 wt:wt ethylene carbonate/ethyl methyl carbonate (EC/EMC) (Novolyte, Independence, Ohio). The cells were cycled using a commercial battery tester (Series 4000, Maccor, Tulsa, Okla.) at ambient temperature (˜22° C.) using voltage limits of 1.9-3.4 V. The first two charge-discharge cycles were 0.24 mA constant current (CC) steps to the voltage limit, followed by constant voltage (CV) steps until the current decayed (tapered) to 0.06 mA. The third cycle included a 10 hr CV charge step, while the fourth discharge began at 9.5 mA. Cycles 5-44 used 1.2 mA CC followed by CV current taper to 0.06 mA, followed by a 1.2 mA CC discharge. The discharge capacity normalized to the mass of LNMO, mAh per g of LNMO, remaining after the last 40 cycles is indicated in Table 4.

### Comparative Examples 4-5 and Examples 3-4

Positive electrode Preparation: A positive electrode paste was made similar to that used for Examples 1 and 2, except the a mixture of carbon blacks was used and the black/binder ratio was altered to 7:7:
3.44 g LNMO
2.33 g 12% PVDF solution in NMP
0.93 g 15% acetylene black (Denka Black, Denka Corp., Japan) dispersion in NMP
0.93 g 15% furnace black (C•Nergy™ Super C65) in NMP
2.37 g NMP

The carbon blacks and PVDF solution were first combined and centrifugally mixed for 120 s at 2000 rpm. The LNMO powder was ground with a mortar and pestle, and along with the additional NMP, was added to the carbon blacks and PVDF mixture. The paste was centrifugally mixed for 120 s at 2000 rpm. The electrode paste was dried in a vacuum oven with a nitrogen bleed at 120° C. for 40 minutes. After removal of NMP, the positive electrode consisted of 86% LNMO, 7% binder, and 7% carbon blacks. The electrode was calendered at ambient temperature using a manually-operated calender with 60 mm dia.×150 mm steel rolls (model DRM F150, Durston Rolling Mills, Buckinghamshire, England). The electrode thickness after calendaring was 54 micrometer and the LNMO loading was 9 mg/cm².

Negative electrode: The LTO electrode was obtained from Farasis Energy Inc. (Hayward, Calif.). The LTO used was Nanomyte™ BE-10 from NEI Corporation. The current collector was copper foil. The composition was 97:9:4 LTO:binder:carbon black, the thickness was 102 micrometer, and the LTO loading was 10 mg/cm².

Coin Cells: 2,2-Difluoroethyl acetate (DFEA), obtained from Matrix Scientific (Columbia, S.C.), was purified by spinning band distillation twice to 99.99% purity, as determined by gas chromatography using a flame ionization detector. The purified 2,2-difluoroethyl acetate (7.32 g) and 3.10 g of ethylene carbonate (99%, anhydrous, Sigma-Aldrich, Milwaukee, Wis.) were mixed together. To 9.0 ml of the resulting solution was added 1.35 g of lithium hexafluorophosphate (99.99% battery grade, Sigma-Aldrich) and the mixture was shaken for a few minutes until all the solid was dissolved.

4-Fluoro-1,3-dioxolan-2-one (FEC), obtained from China LangChem INC, (Shanghai, China), was purified by vacuum distillation. The purified 4-fluoro-1,3-dioxolan-2-one (0.053 g) was added to 5.30 g of the nonaqueous electrolyte composition described above and the mixture was shaken for several minutes to give electrolyte “LiPF₆/EC/DFEA/FEC”.

Coin cells were made in a similar manner to Example 1, using the above electrolyte, except for Examples 3-4 the separator was nanofiber polyimide and for Comparative Examples 6-7 the separator was a microporous polyolefin (Celgard™ 2300).

An electroblowing process and apparatus for forming a nanofiber web of the invention as disclosed in WO 2003/080905 was used to produce the nanofiber layers and webs of Examples 3 and 4. Polyamic acid webs were prepared from a solution of PMDA/ODA in dimethyl formamide (DMF) and electroblown using the electroblowing process and apparatus for forming a nanofiber web as described in WO 2003/080905. The polyamic acid webs were than calendered through a steel/cotton nip at 500 pli and 90° C. followed by a heat treatment according to the procedure described in copending published US Patent Application No. 2011/0144297. Table 2 summarizes the properties of the resulting nanoweb used for Examples 3 and 4. All nanowebs were composed of fully imidized polyimide fibers having an average fiber size between 600 and 800 nm.

TABLE 2
Properties of Nanoweb Used for Examples 3 and 4.

| Property | Units | Value |
|---|---|---|
| Basis Weight | GSM | 15.4 |
| Thickness | Micrometer | 20.6 |
| Porosity | % | 47.8 |
| Gurley | Sec/100 cc | 2.7 |
| Mean Flow Pore | Micrometer | 0.8 |
| Resistance | Ohms-cm² | 1.44 |
| Tensile Strength | MPa | 38 |
| Modulus | MPa | 922 |

The cells were cycled at 55° C. using Arbin and Maccor testers. The procedure for both instruments cycled the cells between voltage limits of 1.9 to 3.4 V using CC charging and discharging at 2 mA. The discharge capacity normalized to the mass of LNMO, mAh per g of LNMO, remaining after 44 cycles is indicated in Table 4

### Comparative Examples 6-7 and Examples 5-6

### Preparation of LiMn_{1.5}Ni_{0.42}Fe_{0.08}O₄ (Fe-LNMO) Positive Electrode Active Material

For the preparation of LiMn_{1.5}Ni_{0.42}Fe_{0.08}O₄, 401 g manganese (II) acetate tetrahydrate (Aldrich 63537), 121 g nickel (II) acetate tetrahydrate (measured to have 4.8 water of hydration) (Aldrich 72225) and 15.25 g iron (II) acetate anhydrous (Alfa Aesar 31140) were weighed into bottles on a balance then dissolved in 5 L of deionized water. KOH pellets were dissolved in 10 L of deionized water to produce a 3M solution inside a 30 L reactor. The acetate solution was transferred to an addition funnel and dripped into the rapidly stirred reactor to precipitate the mixed hydroxide material. Once all 5 L of the acetate solution was added to the reactor stirring was continued for 1 hr. Then stirring was stopped and the precipitate was allowed to settle overnight. After settling the liquid was removed from the reactor and 15 L of fresh deionized water was added. The contents of the reactor were stirred, allowed to settle again, and liquid removed. This rinse process was repeated. Then the precipitate was transferred to two (split evenly) coarse glass frit filtration funnels covered with Dacron® paper. The solids were rinsed with deionized water until the filtrate pH reached 6 (pH of deionized rinse water), and a further 20 L of deionized water was added to each filter cake. Finally the cakes were dried in a vacuum oven at 120° C. overnight. The yield at this point was typically 80-90%.

The hydroxide precipitate was next ground and mixed with lithium carbonate. This step was done in 50 g batches using a Fritsche Pulverisette automated mortar and pestle. For each batch the hydroxide mixture was weighed, then ground alone for 5 minutes in the Pulveresette. Then a stoichiometric amount with small excess of lithium carbonate was added to the system. For 50 g of hydroxide 10.5 g of lithium carbonate was added. Grinding was continued for a total of 60 minutes with stops every 10-15 minutes to scrape the material off of the surfaces of the mortar and pestle with a sharp metal spatula. If humidity caused the material to form clumps, it was sieved through a 40 mesh screen once during grinding, then again following grinding.

The ground material was fired in an air box furnace inside shallow rectangular alumina trays. The trays were 158 mm by 69 mm in size, and each held about 60 g of material. The firing procedure consisted of ramping from room temperature to 900° C. in 15 hours, holding at 900° C. for 12 hours, then cooling to room temperature in 15 hours.

Positive electrode: A positive electrode paste was made similar to that used for Examples 1-2, except that Fe-LNMO described above was used as the positive electrode active material, all the carbon black was acetylene black, and the composition of the dried electrode was 80:10:10 active:binder:black. The paste used:

2.08 g Fe-LNMO

0.260 g acetylene black, Denka uncompressed

2.16 g 12% PVDF solution in NMP

4.58 g NMP

The carbon black, 3.88 g of NMP, and the PVDF solution were combined in a 15 ml borosilicate vial with a fluoropolymer cap and centrifugally mixed three times for 1 minute each at 2000 rpm. The vial was removed from the Thinky and allowed to cool for about 1 min. between each mixing. The Fe-LNMO was ground using a mortar and pestle for approximately an hour. The Fe-LNMO and 0.70 g of NMP were then added and the mixture was again centrifugally mixed three times for 1 minute each at 2000 rpm. The vial was mounted in an ice bath and homogenized twice using a rotor-stator (model PT 10-35 GT, 7.5 mm dia. stator, Kinematicia, Bohemia, N.Y.) for 15 minutes each at 6500 rpm and then twice more for 15 minutes at 9500 rpm. Between each of the four homogenization periods, the homogenizer was moved to another position in the paste vial. The paste was cast on to untreated aluminum foil and dried in the vacuum oven for 15 minutes. The initial thickness was about 61 μm, after calendaring the thickness was about 42 micrometer, and the loading was about 6.2 mg Fe-LNMO/cm².

Negative electrode: Negative electrode paste used contained:

2.08 g LTO

2.00 g 12% PVDF solution in NMP

0.26 g acetylene black, Denka uncompressed

4.75 g NMP

The carbon black, 4.02 g of NMP, and half the PVDF solution were combined in a 15 ml borosilicate vial with a fluoropolymer cap and centrifugally mixed three times for 1 minute each at 2000 rpm. The vial was removed from the Thinky and allowed to cool for about 1 min. between each mixing. The LTO and 0.73 g of NMP were then added and the mixture was again centrifugally mixed three times for 1 minute each at 2000 rpm. The vial was mounted in an ice bath and homogenized twice using a rotor-stator (model PT 10-35 GT, 7.5 mm dia. stator, Kinematicia, Bohemia, N.Y.) for 15 minutes each at 6500 rpm and then twice more for 15 minutes at 9500 rpm. The remaining PVDF solution was added and the mixture mixed centrifugally three times for 1 min. each at 2000 rpm. The paste was cast on to untreated aluminum foil using a 0.15 mm gate and dried in a convection oven (model FDL-115, Binder Inc., Great River, N.Y.) vacuum oven for 15 minutes at 100° C. Electrode thicknesses before and after calendaring were 77 and 54 μm, and the loading was about 6 mg LTO/cm².

Coin cells were made similarly to Examples 3-4, except the negative electrodes were punched to a diameter slightly larger diameter than the positive electrodes. Comparative Examples 6-7 used a 25 μm thick polyolefin separator (Celgard™ 2325) while Examples 5-6 used a nanofiber polyimide separator. The cells were mounted in an environmental chamber held at 55° C. and cycled using a Maccor 4000 series tester. The cycling procedure used voltage limits of 1.9-3.4 V. The cells were charged and discharged CC 29 times using a current of 60 mA/g of Fe-LNMO, then cycled once using 24 mA/g. This sequence of 30 cycles was repeated several times until a total of 250 cycles had been obtained. The discharge capacity normalized to the mass of LNMO, mAh per g of LNMO, remaining after cycling is indicated in Table 4

### Comparative Examples 8-11 and Examples 7-9

The Fe-LNMO positive electrode was prepared similarly to Example 5, except the stoichiometry was adjusted to give LiFe_{0.05}Ni_{0.45}MnO₄, and the powder was jar milled in isopropanol using yttria-stabilized zirconia (YSZ) 5 mm spherical media. The positive electrodes were made with a procedure similar to that of Example 5.

Negative electrode—A negative electrode paste was made using:

2.574 g graphite (G5, ConocoPhillips, Huston, Tex.)
0.1095 g Super P carbon black (Timcal, Westlake, Ohio)
1.32 g pVDF (Kureha 9130 (13% in NMP)
0.0049 g oxalic acid

### 5.99+0.92 g NMP

The paste was prepared and cast using a similar procedure to that of Example. 5, but the current collector foil was 10 μm electro-deposited copper foil (CF-LBX-10, Fukuda, Kyoto, Japan). After drying, the electrode composition was 90:3.83:6:0.17 graphite:carbon black:pVDF:oxalic acid.

An electroblowing process and apparatus for forming a nanofiber web of the invention as disclosed in PCT publication number WO 2003/080905, was used to produce the nanofiber layers and webs of Examples 7 to 9. Polyamic acid webs were prepared from a solution of PMDA/ODA in dimethyl formamide (DMF) and electroblown as described herein. The polyamic acid webs were than calendared through a steel/cotton nip at 1000 pli and 160° C. followed by a heat treatment according to the procedure described in copending published US Patent Application 2011/0144297. Table 3 summarizes the properties of the resulting nanoweb used for Examples 7 to 9. All nanowebs were composed of fully imidized polyimide fibers having an average fiber size between 600 and 800 nm.

TABLE 3
Properties of Nanoweb

| Property | Units | Values |
|---|---|---|
| Basis Weight | GSM | 22 |
| Thickness | Micrometer | 25.1 |
| Porosity | % | 38.9 |
| Gurley | Sec/100 cc | 27.6 |
| Mean Flow Pore | Micrometer | 0.4 |
| Resistance | Ohms-cm² | 3.47 |
| MacMullen No | — | 11.6 |
| Tensile Strength | MPa | 48.7 |
| Modulus | MPa | 1283 |

A polyimide nanofiber separator for Examples 7-9 was prepared as described and further coated with a thin layer of zirconium oxide as described in published US patent application US 2015/0325831 A1, which is incorporated herein by reference in its entirety. Comparative Examples were prepared using a PP/PE/PP trilayer polyolefin separator (CG2300, Celgard™ 2300 series, CG2325, Celgard™ 2325, Charlotte, N.C.). Coin cells were made using 13.4 mm diameter positive electrodes and 15.3 mm diameter negative electrodes. The ratio of the masses of graphite:Fe-LNMO in the cells was 0.70-0.72 for Example 7 and Comp. Examples 8-9, and 0.55-0.56 for Examples 8-9 and Comp. Examples 10-11. Cells were cycled between voltage limits of 3.4-4.9V. The cells were first given two formation cycles at ambient temperature using CC 12 mA per g Fe-LNMO. This was followed by 300 cycles at 55° C. using CC of 120 mA/g, except that every 30^{th} cycle was at 24 mA/g. The discharge capacity, normalized to the mass of LNMO, mAh per g of Fe-LNMO, remaining after cycling is indicated in Table 4. The cell with Pl+ZrO₂ separators retain more capacity than do the cells with polyolefin separators

TABLE 4
Results for Comparative Examples 1-11 and Examples 1-9

| | | | | | Cycling | | Capacity |
|---|---|---|---|---|---|---|---|
| | | Negative | | Positive | Temp | No. | at end |
| Example | Separator | electrode | Electrolyte | electrode | ° C. | Cycles | mAh/g |
| CEx. 1 | CG2340 | LTO | LiPF₆/EC/EMC | LNMO | 22 | 40 | 112 |
| CEx. 2 | CG2320 | LTO | LiPF₆/EC/EMC | LNMO | 22 | 40 | 114 |
| CEx. 3 | CG2340 | LTO | LiPF₆/EC/EMC | LNMO | 22 | 40 | 112 |
| Ex. 1 | PI-NF | LTO | LiPF₆/EC/EMC | LNMO | 22 | 40 | 116 |
| Ex. 2 | PI-NF | LTO | LiPF₆/EC/EMC | LNMO | 22 | 40 | 123 |
| CEx. 4 | CG2300 | LTO | LiPF₆/EC/DFEA/FEC | LNMO | 55 | 44 | 54 |
| CEx. 5 | CG2300 | LTO | LiPF₆/EC/DFEA/FEC | LNMO | 55 | 44 | 9 |
| Ex. 3 | PI-NF | LTO | LiPF₆/EC/DFEA/FEC | LNMO | 55 | 44 | 81 |
| Ex. 4 | PI-NF | LTO | LiPF₆/EC/DFEA/FEC | LNMO | 55 | 44 | 76 |
| CEx. 6 | CG2325 | LTO | LiPF₆/EC/DFEA/FEC | Fe- | 55 | 250 | 57 |
| | | | | LNMO | | | |
| CEx. 7 | CG2325 | LTO | LiPF₆/EC/DFEA/FEC | Fe- | 55 | 250 | 49 |
| | | | | LNMO | | | |
| Ex. 5 | PI-NF | LTO | LiPF₆/EC/DFEA/FEC | Fe- | 55 | 250 | 82 |
| | | | | LNMO | | | |
| Ex. 6 | PI-NF | LTO | LiPF₆/EC/DFEA/FEC | Fe- | 55 | 250 | 68 |
| | | | | LNMO | | | |
| CEx. 8 | CG2325 | C | LiPF₆/EC/DFEA/FEC | Fe- | 55 | 299 | 38 |
| | | | | LNMO | | | |
| CEx. 9 | CG2325 | C | LiPF₆/EC/DFEA/FEC | Fe- | 55 | 299 | 45 |
| | | | | LNMO | | | |
| Ex. 7 | PI + ZrO₂ | C | LiPF₆/EC/DFEA/FEC | Fe- | 55 | 299 | 48 |
| | | | | LNMO | | | |
| CEx. | CG2325 | C | LiPF₆/EC/DFEA/FEC | Fe- | 55 | 299 | 38 |
| 10 | | | | LNMO | | | |
| CEx. | CG2325 | C | LiPF₆/EC/DFEA/FEC | Fe- | 55 | 299 | 42 |
| 11 | | | | LNMO | | | |
| Ex. 8 | PI + ZrO₂ | C | LiPF₆/EC/DFEA/FEC | Fe- | 55 | 299 | 45 |
| | | | | LNMO | | | |
| Ex. 9 | PI + ZrO₂ | C | LiPF₆/EC/DFEA/FEC | Fe- | 55 | 299 | 45 |
| | | | | LNMO | | | |

PI-NF—polyimide nanofiber
PI + ZrO₂—coated polyimide nanofiber
CEx—Comparative Example
Ex—Example

### Comparative Examples 12-15 and Examples 10-11

Stacked pouch cells were prepared by stacking the negative electrodes and positive electrodes separated by one layer of separator. The layers of electrodes and separators are stacked together and sealed in a plastic pouch cells after being filled with electrolyte. The negative electrode was graphitic carbon, the positive electrode was NMC 532 ((Li(Ni₅Mn₂Co₃)O₂), and the electrolyte formulation was obtained from Farasis (Hayward, Calif.). The separators were trilayer polyolefin separators (Celgard™ 2320), polyethylene separator (Toray Tonen Specialty Separator, Gumi, Korea), and nanofiber polyimide separator, as described above.

The cells were then formed by charging/discharging at 15 mA for two cycles by keeping the lower cutoff voltage at 3.0 V and upper cutoff voltage was varied from 4.2 to 4.6 V. All cells were cycled at room temperature during formation. Next, all cells were cycled at 50 mA constant current charge followed by 5 minute constant voltage step and then discharged at 50 m A constant current. Every 20 cycles, the cells were charged/discharged at 20 mA. The lower cutoff voltage was kept at 3.0 V for all cells and upper cutoff voltage was varied from 4.2 to 4.6 V.

The results are shown in Table 5 below.

TABLE 5
Results for Comparative Examples 12-15 and Examples 10-11

| | | Discharge | | Discharge Capacity | | | Discharge | |
|---|---|---|---|---|---|---|---|---|
| | | Capacity (4.2 V) | | (4.4 V) | | | Capacity (4.6 V) | |
| | | Cycle | Cycle | Cycle | Cycle | Cycle | | Cycle |
| | Separator | 25 | 50 | 15 | 30 | 50 | Cycle 5 | 40 |
| CEx. 12 | CG2320 | 127.44 | 127.11 | 96.96 | 90.89 | 82.58 | 108.00 | 22.71 |
| CEx. 13 | CG2320 | 129.16 | 129.08 | 80.39 | 71.45 | 67.04 | 104.10 | 16.61 |
| CEx. 14 | Tonen | 130.82 | 127.69 | 77.88 | 57.40 | 44.39 | 101.00 | 15.07 |
| CEx. 15 | Tonen | 133.44 | 128.55 | 45.00 | 40.17 | 38.20 | 70.97 | 13.80 |
| Ex. 10 | NF-PI | 122.91 | 118.99 | 125.70 | 115.36 | 106.45 | 126.78 | 34.33 |
| Ex. 11 | NF-PI | 126.48 | 118.80 | 133.47 | 119.63 | 103.90 | 120.30 | 34.91 |

What is claimed is:

1. An electrochemical cell comprising a housing containing an electrolyte composition, and a multi-layer article at least partially immersed in the electrolyte composition;
wherein the multi-layer article comprises a first metallic current collector, a negative electrode material in electrically conductive contact with the first metallic current collector, a positive electrode material in ionically conductive contact with the negative electrode material, a porous separator disposed between and contacting the negative electrode material and the positive electrode material, and a second metallic current collector in electrically conductive contact with the positive electrode material;
wherein the porous separator comprises a nanoweb that comprises a plurality of nanofibers, wherein the nanofibers consist essentially of a fully aromatic polyimide; and
wherein the positive electrode material is charged above 4.4 V versus a Li metal reference electrode.

2. The electrochemical cell of claim 1, wherein the nanoweb is characterized by a crystallinity index of at least 0.1.

3. The electrochemical cell of claim 1, wherein the nanoweb consists essentially of polyimide nanofibers formed from pyromellitic dianhydride and oxy-dianiline.

4. The electrochemical cell of claim 1, wherein the separator comprises a nanoweb comprising nanofibers with a fiber size less than about 1000 nanometers in diameter.

5. The electrochemical cell of claim 1, wherein the polyimide separator is prepared by one or more of electrospinning and electroblowing.

6. The electrochemical cell of claim 1, wherein the polyimide separator has a thickness about 5 to about 50 micrometers.

7. The electrochemical cell of claim 1, wherein the polyimide separator is facing the positive electrode.

8. The electrochemical cell of claim 1, wherein the positive electrode material has a capacity of greater than about 40 mAh/g in a voltage range greater than about 4.6 V.vs Li/Li+.

9. The electrochemical cell of claim 8, wherein the positive electrode material is charged to an upper charging voltage greater than about 4.8 V. vs Li/Li+.

10. The electrochemical cell of claim 8, wherein the positive electrode material comprises:
a) a lithium-containing manganese composite oxide having a spinel structure as active material, the lithium-containing manganese composite oxide comprising oxides of the formula
LiₓNi_{y}M_{z}Mn_{2-y-z}O_{4-d}
wherein x is 0.03 to 1.0; x changes in accordance with release and uptake of lithium ions and electrons during charge and discharge; y is 0.3 to 0.6; M comprises one or more of Cr, Fe, Co, Li, Al, Ga, Nb, Mo, Ti, Zr, Mg, Zn, V, and Cu; z is 0.01 to 0.18, and d is 0 to 0.3; or
b) a composite material represented by the formula:
x(Li_{2-w}A₁₋ᵥQ_{w+v}O₃₋ₑ)*(1−x)(Li_{y}Mn_{2-z}M_{z}O_{4-d})
wherein:
x is about 0 to about 0.1;
A comprises one or more of Mn or Ti;
Q comprises one or more of Al, Ca, Co, Cr, Cu, Fe, Ga, Mg, Nb, Ni, Ti, V, Zn, Zr or Y;
e is 0 to about 0.3;
v is 0 to about 0.5;
w is 0 to about 0.6;
M comprises one or more of Al, Ca, Co, Cr, Cu, Fe, Ga, Li, Mg, Mn, Nb, Ni, Si, Ti, V, Zn, Zr or Y;
d is 0 to about 0.5;
y is about 0 to about 1;
z is about 0.3 to about 1; and
wherein the Li_{y}Mn_{2-z}M_{z}O_{4-d} component has a spinel structure and the Li_{2-w}Q_{w+v}A₁₋ᵥO₃₋ₑ component has a layered structure; or
c) a composition of the formula LiₐNi_{b}Mn_{c}Co_{d}RₑO_{2-f}Z_{f},
wherein:
R is Al, Ni, Co, Mn, Cr, Fe, Mg, Sr, V, Zr, Ti, a rare earth element, or a combination thereof, and Z is F, S, P, or a combination thereof; and 0.8≦a≦1.2, 0.1≦b≦0.9, 0.0≦c≦0.7, 0.05≦d≦0.4, 0≦e≦0.2; wherein the sum of b+c+d+e is about 1; and 0≦f≦0.08; or
d) a composition of the formula LiₐA₁₋ₓRₓDO_{4-f}Z_{f},
wherein:
A is Fe, Mn, Ni, Co, V, or a combination thereof;
R is Al, Ni, Co, Mn, Cr, Fe, Mg, Sr, V, Zr, Ti, a rare earth element, or a combination thereof;
D is P, S, Si, or a combination thereof;
Z is F, CI, S, or a combination thereof;
0.8≦a≦2.2;
0≦x≦0.3; and
0≦f≦0.1; or
e) a composition of the formula LiₐA_{1-b},R_{b}D₂,
wherein:
A is Ni, Co, Mn, or a combination thereof;
R is Al, Ni, Co, Mn, Cr, Fe, Mg, Sr, V, Zr, Ti, a rare earth element, or a combination thereof;
D is O, F, S, P, or a combination thereof; and
0.90≦a≦1.8 and 0≦b≦0.5.

11. The electrochemical cell of claim 10, wherein M in the composition of a), b), or c) is one or more of Ni, Cu, Cr, Fe, Co, and V; A is one or more of Fe, Mn, and Ni; and B is one or more of Ni and Fe.

12. The electrochemical cell of claim 10, wherein cell retains greater than about 50% of its capacity when cycled for 300 cycles at a rate between 0.4C and 2C at a temperature of about 55° C.

13. The electrochemical cell of claim 1, wherein the electrolyte composition comprises at least one electrolyte salt and greater than about 20 weight percent of at least one fluorinated acyclic carboxylic acid ester, fluorinated acyclic carbonate, fluorinated acyclic ether, fluorinated ether, fluorinated cyclic carbonate, or fluorine-containing carboxylic acid ester.

14. The electrochemical cell of claim 13, wherein the fluorinated acyclic carboxylic acid ester is represented by the formula
R¹—COO—R²,
wherein R¹ is selected from the group consisting of CH₃, CH₂CH₃, CH₂CH₂CH₃, CH(CH₃)₂, CF₃, CF₂H, CFH₂, CF₂R₇, CFHR₇, and CH₂R_{f}, and R² is independently selected from the group consisting of CH₃, CH₂CH₃, CH₂CH₂CH₃, CH(CH₃)₂, and CH₂R_{f}, where R₇ is a C₁ to C₃ alkyl group which is optionally substituted with at least one fluorine, and R_{f} is a C₁ to C₃ alkyl group substituted with at least one fluorine, and further wherein at least one of R¹ or R² contains at least one fluorine and when R¹ is CF₂H, R² is not CH₃; and
wherein the fluorinated acyclic carbonate is represented by the formula
R³—OCOO—R⁴,
wherein R³ and R⁴ are independently selected from the group consisting of CH₃, CH₂CH₃, CH₂CH₂CH₃, CH(CH₃)₂, and CH₂R_{f} where R_{f} is a C₁ to C₃ alkyl group substituted with at least one fluorine, and further wherein at least one of R³ or R⁴ contains at least one fluorine; and
wherein the fluorinated cyclic carbonate is represented by the structure: 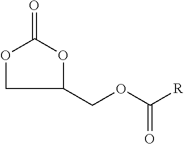
wherein R is a C₁ to C₄ fluoroalkyl group.

15. The electrochemical cell of claim 1, wherein the nanoweb comprises a protective region which impedes electrochemical polyimide reduction.

16. The electrochemical cell of claim 1, wherein the negative electrode material comprises at least one of carbon, graphite, lithium titanates, lithium-tin alloy, silicon, or mixtures thereof.

17. The electrochemical cell of claim 13, wherein the fluorinated cyclic carbonate comprises 4-fluoro-1,3-dioxolan-2-one; 4,5-difluoro-1,3-dioxolan-2-one; 4,5-difluoro-4-methyl-1,3-dioxolan-2-one; 4,5-difluoro-4,5-dimethyl-1,3-dioxolan-2-one; 4,4-difluoro-1,3-dioxolan-2-one; 4,4,5-trifluoro-1,3-dioxolan-2-one; or mixtures thereof.

18. The electrochemical cell of claim 1, wherein the electrolyte composition comprises at least one electrolyte salt and greater than about 20 weight percent of at least one fluorinated acyclic carboxylic acid ester, fluorinated acyclic carbonate, fluorinated acyclic ether, or mixture thereof;
wherein
the fluorinated acyclic carboxylic acid ester is represented by the formula R¹—COO—R²;
the fluorinated acyclic carbonate is represented by the formula R³—OCOO—R⁴; and
the fluorinated acyclic ether is represented by the formula R⁵—O—R⁶;
wherein
i) R¹ is H, an alkyl group, or a fluoroalkyl group;
ii) R³ and R⁵ is each independently a fluoroalkyl group and can be either the same as or different from each other;
iii) R², R⁴, and R⁶ is each independently an alkyl group or a fluoroalkyl group and can be either the same as or different from each other;
iv) either or both of R¹ and R² comprises fluorine; and
v) R¹ and R², R³ and R⁴, and R⁵ and R⁶, each taken as a pair, comprise at least two carbon atoms but not more than seven carbon atoms.

19. The electrochemical cell of claim 1, wherein the electrochemical cell is a lithium ion battery.

20. An electronic device, a telecommunications device, or a transportation device, comprising an electrochemical cell according to claim 1.
